(19) United States
(12) Patent Application Publication
(10) Pub. No.: US 2006/0033424 A1
(43) Pub. Date: Feb. 16, 2006

(54) Dual emissive electroluminescent displays and fabricating and display methods thereof

(76) Inventor: Chung-Wen Ko, Sijhih City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/979,501

(22) Filed: Nov. 2, 2004

(30) Foreign Application Priority Data
Aug. 12, 2004 (TW) 93124171

(51) Int. Cl. H05B 33/00; H05B 33/02

(52) U.S. Cl. 313/501; 313/506; 313/503

(57) ABSTRACT

A dual emissive display wherein images shown on each side of the display are not affected by a background image. The dual emissive display includes an emissive display device, a first polarizer and a second polarizer, wherein the first and second polarizers are located on different sides of the display and the polarizations thereof are orthogonal to each other. Fabrication and display methods of the dual emissive display are also provided.

### BACKGROUND

The invention relates to flat panel displays and, in particular, to dual emissive electroluminescent displays.

Recently, transparent cathodes and anodes are utilized in organic light emitting diode (OLED) displays to implement a dual emissive display 100, as shown in FIG. 1. Due to transparency of the display 100, a background image interferes with a normal display image. Thus, it is difficult to distinguish the actual display image from the background image.

### SUMMARY

An embodiment of a dual emissive electroluminescent display comprises an electroluminescent device, a first linear polarizer and a second linear polarizer. The first and second linear polarizers are located on first and second sides of the electroluminescent device, respectively. The angle between polarizations of the first and second linear polarizer is 80 to 100 degrees.

An embodiment of a fabricating method for a dual emissive electroluminescent display comprises forming a transparent dual emissive electroluminescent device; arranging a first linear polarizer on a first side of an electroluminescent device and arranging a second linear polarizer on a second side of the electroluminescent device, wherein the angle between polarizations of the first and second linear polarizer is 80 to 100 degrees.

An embodiment of a display method for a dual emissive electroluminescent display comprises converting a light incident on a first side thereof to a linearly polarized light with a first linear polarizer; and preventing the linearly polarized light from penetrating the electroluminescent display with a second linear polarizer; wherein the first and second polarizers are arranged on different sides of the electroluminescent display, and the angle between polarizations of the first and second linear polarizers is 80 to 100 degrees.

### DESCRIPTION OF THE DRAWINGS

FIG. 1 is a schematic diagram of a dual emissive display.

FIG. 2 shows a schematic diagram of an embodiment of a dual emissive electroluminescent display.

FIG. 3 is a schematic diagram of equivalent circuits of pixel circuits in a column.

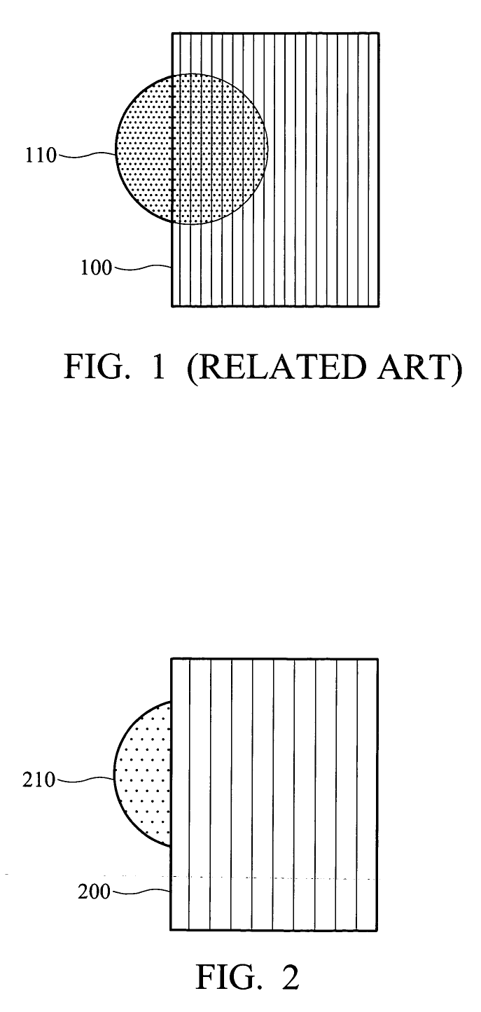

### DETAILED DESCRIPTION

FIG. 2 shows an embodiment of a dual emissive electroluminescent display 200. The display image thereof is not affected by a background image 210. The details are described in the following description.

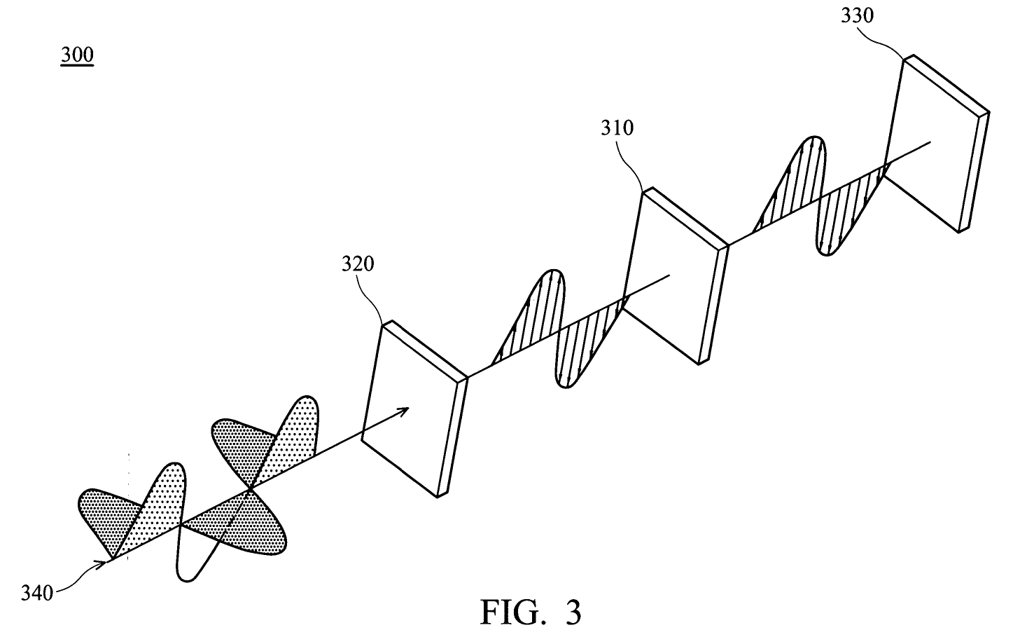

An OLED display is given as an example in this disclosure, but is not limited thereto in practice. As shown in FIG. 3, the dual emissive electroluminescent display 300 comprises an electroluminescent device 310, a first linear polarizer 320 and a second linear polarizer 330. The first linear polarizer 320 and second linear polarizer 330 are located on first and second sides of the electroluminescent device 310, respectively. The angle between polarizations of the first linear polarizer 320 and second linear polarizer 330 is 80 to 100 degrees. Preferably, the angle between polarizations of the first linear polarizer 320 and second linear polarizer 330 is 90 degrees. A first transparent electrode (anode or cathode, not shown in the figure) is typically disposed on a first side of an organic layer stack, comprising a hole injection layer, a hole transport layer, an emissive layer, and an electron injection layer, of electroluminescent device 310. Another complementary transparent electrode (cathode or anode, not shown in the figure) is disposed on a second side of the electroluminescent device 310. Since transparent electrodes are used, the electroluminescent display has dual emission properties. An image on either side of the electroluminescent display 300 can be seen through the first linear polarizer 320 or the second linear polarizer 330.

Regarding a background image, as shown in FIG. 3, a background light 340 entering a first linear polarizer 320, is converted to a linearly polarized light. The linearly polarized light encounters a second linear polarizer 330 after it passes through the electroluminescent device 310. Since the angle between polarizations of the first linear polarizer 320 and second linear polarizer 330 is 80 to 100 degrees, preferably 90 degrees, the linearly polarized light cannot pass the second linear polarizer 330. Thus, the background light does not interfere with the display image.

An embodiment of a fabricating method for a dual emissive electroluminescent display comprises forming a transparent dual emissive electroluminescent device 310; arranging a first linear polarizer 320 on a first side of the electroluminescent device 310; and arranging a second linear polarizer 330 on a second side of the electroluminescent device 310, wherein the angle between polarizations of the first linear polarizer 320 and second linear polarizer 330 is 80 to 100 degrees, preferably 90 degrees.

An embodiment of a display method of a dual emissive electroluminescent display comprises converting a light incident on a first side of the electroluminescent device 300 to a linearly polarized light with a first linear polarizer 320; and preventing the linearly polarized light from penetrating electroluminescent device 300 with a second linear polarizer 330; wherein the first and second polarizers are arranged on different sides of the electroluminescent device 300. The angle between polarizations of the first and second linear polarizer is 80 to 100 degrees.

Some embodiments of the invention utilize two orthogonal linear polarizers on different sides of an electroluminescent display to eliminate interference of a background image. Thus, a transparent dual emissive display without background image interference is provided.

While the invention has been described by way of example and in terms of preferred embodiment, it is to be understood that the invention is not limited thereto. To the contrary, it is intended to cover various modifications and (as would be apparent to those skilled in the art). Therefore, the scope of the appended claims should be accorded the broadest interpretation so as to encompass all such modifications.

What is claimed is:

1. A dual emissive electroluminescent display, comprising:
a transparent dual emissive electroluminescent device;
a first linear polarizer disposed on a first side of the electroluminescent device; and
a second linear polarizer disposed on a second side of the electroluminescent device;
wherein an angle between polarizations of the first and second linear polarizers is 80 to 100 degrees.

2. The dual emissive electroluminescent display as claimed in claim 1, wherein the angle between polarizations of the first and second linear polarizers is substantially 90 degrees.

3. The dual emissive electroluminescent display as claimed in claim 1, wherein the electroluminescent device is an organic light emitting device.

4. A method for fabricating a dual emissive electroluminescent display, comprising:
forming a transparent dual emissive electroluminescent device;
arranging a first linear polarizer on a first side of the electroluminescent device; and
arranging a second linear polarizer on a second side of the electroluminescent device;
wherein an angle between polarizations of the first and second linear polarizer is 80 to 100 degrees.

5. The method as claimed in claim 5, wherein the angle between polarizations of the first and second linear polarizer is substantially 90 degrees.

6. The method as claimed in claim 5, wherein the electroluminescent device is an organic light emitting device.

7. A display method for a dual emissive electroluminescent display, comprising:
converting a light incident on a first side of a transparent dual emissive electroluminescent device to a linearly polarized light with a first linear polarizer; and
preventing the linearly polarized light from penetrating the electroluminescent device with a second linear polarizer;
wherein the first and second polarizer are arranged on different sides of the electroluminescent display, wherein the angle between polarizations of the first and second linear polarizers is 80 to 100 degrees.

8. The display method as claimed in claim 7, wherein the angle between polarizations of the first and second linear polarizers is substantially 90 degrees.

9. The display method as claimed in claim 8, wherein the electroluminescent device is an organic light emitting device.
